(19) United States
(12) Patent Application Publication
(10) Pub. No.: US 2025/0326343 A1
(43) Pub. Date: Oct. 23, 2025

(54) UNIVERSAL USE CAR SEAT GAP FILLER

(71) Applicant: Siqing Xu, Shenzhen (CN)

(72) Inventor: Siqing Xu, Shenzhen (CN)

(21) Appl. No.: 18/963,696

(22) Filed: Nov. 28, 2024

Related U.S. Application Data
(63) Continuation-in-part of application No. 18/655,225, filed on May 4, 2024, now abandoned.

(30) Foreign Application Priority Data
Apr. 22, 2024 (CN) 2024208359914
May 9, 2024 (WO) IB WIPO148084
May 10, 2024 (WO) PCT/CN2024/092262

(51) Int. Cl. B60N 2/60; B60R 11/00

(52) U.S. Cl. CPC B60N 2/6009; B60R 11/00; B60R 2011/0012

(57) ABSTRACT

A universal use car seat gap filler with user adjustable gap filling device, for the user to be able to actively fill the gaps of their vehicle seats as needed; a sharp or strip shaped items organizing device, for the user to store dangerous items safely; a tiny or small item organizing device, for the user to prevent item loss; a functional expansion apparatus, providing additional features for users.

### CROSS-REFERENCES

This application is based upon and claims the benefit of priority from
U.S. patent application Ser. No. 18/655,225, filled on May 4, 2024,
WIPO or Office Reference: WIPO148084, International Registration No.: DM/240359, Filled on May 9, 2024
China patent application No.: PCT/CN2024/092262, filled on May 8, 2024;
China Patent Application No.: 2024105022477, filled on Apr. 25, 2024
China Patent Application No.: 2024302286489, Filled on Apr. 22, 2024
China Patent Application No.: 2024208359914, Filled on Apr. 22, 2024 REFERENCE TO RELATED PATENTS

US patent No. U.S. D1,011,261 S and China Patent No. CN3085432185, CN308543219S, CN3080456595.

### BACKGROUND OF THE INVENTION

The present invention relates to the technical field of a car seat gap filler, and more specifically relates to the universal use car seat gap filler.

The car seat gap filler not only prevents items from falling into the gaps of the car seat between the consoles, but also has storage functions, and function expansion device.

A prior art, most of these devices have an integrated structure, includes the upper part of the structure which is divided into several zones for storing items, the lower structure as the seat gap-filling part, most car seat gap filler' designs have a shape of a cup holder in the main body to facilitate a placement of water cups for users, however, this structure makes the entire product very wide, even reaching about 75 mm, which greatly occupies the seat space.

Most Car seat gap fillers' gap filling parts are fixed thickness or use compressible sponges to fill the gap, none of which can adapt to the irregular gaps of car seats, This makes the users face six awkward situations, 1) The prior art's filling parts are too thick to be installed; 2) or the filling parts are too thin or too soft to the seat gap, and the installation is not stable, causing the car seat gap filler to shake during vehicle driving; 3) the car seat gap fillers are too wide and takes up seat space; 4) after placing the water cup, most car seat gap fillers tilt forward due to weight gain; 5) small objects and pointed objects cannot be stored safely, may be bumped out, posing safety hazards during the driving; 6) most car seat gap fillers actually have all the items mixed together, difficult to find them.

Therefore, an actual need exists for adjustable thickness of car seat gap filler that allow the users to adjust to fit the gap of his/her car perfectly, to place their water bottles without occupying seat positions, to store small things safely, to know where the items are placed, no longer searching hard, and moreover, the users can enjoy more convenient features brought by functional expansion.

### SUMMARY OF THE INVENTION

The present invention aims to provide a universal car seat gap filler that can be well adjusted by user themselves regardless of the irregularity in seat gap width, a function extension device is configured onto the main bod to facilitate the placement of foldable cup holder, the function of classifying and storing items is also a feature of the present invention.

In order to achieve the above objects, the present invention adopts the following solutions:

A user adjustable gap filling device, comprises a docking device for connecting the main body and an elastic band configured onto a single layer board, the elastic band is divided into plurality sections, forming plurality elastic, fillable spaces between the single-layer board, the filling material is padding pieces.

A user adjustable gap filling device comprises a docking device for connecting the main body, and an airbag which is configured as plurality inflatable small airbags, and the filling material is the air, this is more optional user adjustable gap filling devices solution

A sharp or strip shaped items organizing device, configured to the right side of the main body, comprises clips at different angles with different type, and a trapezoidal container below, forming a room for storing sharp or strip shaped items.

A tiny or small item organizing device, comprises a layer board, a pivot, and a handle, installing the pivot to a shaft seat at the main body, the layer board can be rotated up and down, the handle will be placed against the left groove of a partition baffle while the layer board is placed horizontally, the chamber of the main body is divided into two layers, the lower layer is a relatively independent enclosed space for storing tiny and small items.

A partition baffle is configured at the right of the layer board, dividing the right chamber of the main body to be three sections, for storing the most common used items.

A functional expansion device, configured onto the main body, comprising external device with more functions, realizing function expansion.

### BRIEF DESCRIPTION OF DRAWINGS

FIG. 1 is a diagram showing the main body according to an embodiment 1;

FIG. 2 is a diagram showing the single layer board with docking device according to the embodiment 1;

FIG. 3 is a diagram showing the partition baffle according to the embodiment 1;

FIG. 4 is a diagram showing a layer board, a pivot, a handle, nylon mesh cloth according to the embodiment 1;

FIG. 5 is a diagram showing functional expansion device according to the embodiment 1;

FIG. 6 is a diagram showing the padding piece according to the embodiment 1;

FIG. 7 is a diagram showing a section view according to the embodiment 1;

FIG. 8 is a diagram showing the front view of single layer board with fourteen strip holes according to the embodiment 1;

FIG. 9 is a diagram showing the opening status of layer board and each storing room according to the embodiment 1;

FIG. 10 is a diagram showing the status for the user in the right seat, with a foldable cup holder according to the embodiment 1;

FIG. 11 is a diagram showing the status for the left seat user, before installing a foldable cup holder according to the embodiment 1;

FIG. 12 is a diagram showing alternative solution, a docking device with six small airbags according to the embodiment 2.

### DESCRIPTION OF EMBODIMENTS

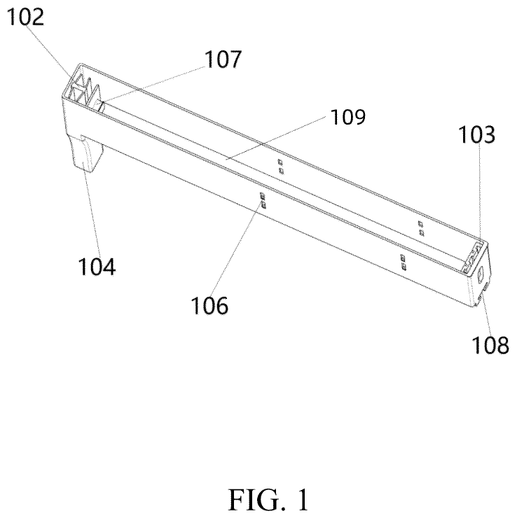

Referring to FIG. 1, the main body 1 comprises clips at different angle with different type 102, and the trapezoidal container 104 at the left side, forming a space for storing long or round items, the shaft seat 107 is for installing the layer board 4, the connection port 103 is at the right end of the main body 1 for connecting the function expansion device 5, the docking device 108 at the bottom of the main body 1 is for combining the docking device of the single layer board 204, four slot sets 106 are on the main body's walls;

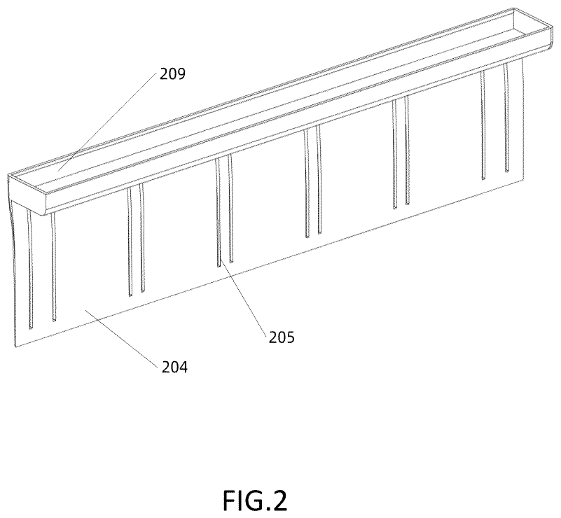

Referring to FIG. 2, the single board structure 204 with fourteen strip holes 205 connected below the docking device 209, the image without strip holes on the single board is omitted in this embodiment.

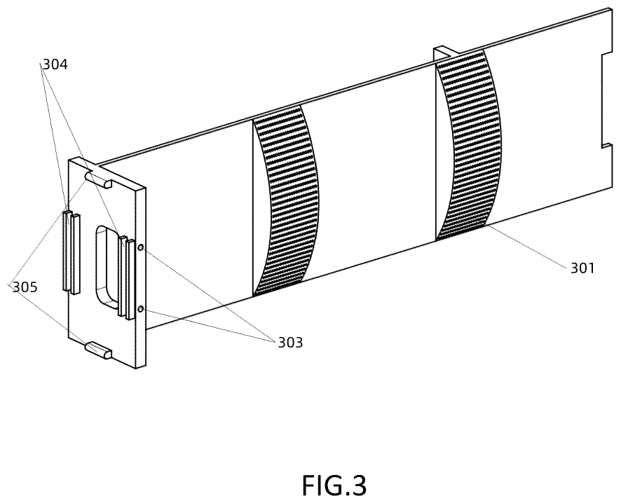

Referring to FIG. 3, the partition baffle 3 comprises two curved anti-collision materials 301, four insert-sets 303 for connecting the main body 1, two grooves 304 is for the handle 404 of the layer board 4 to be pressed against, Handle limiters 305.

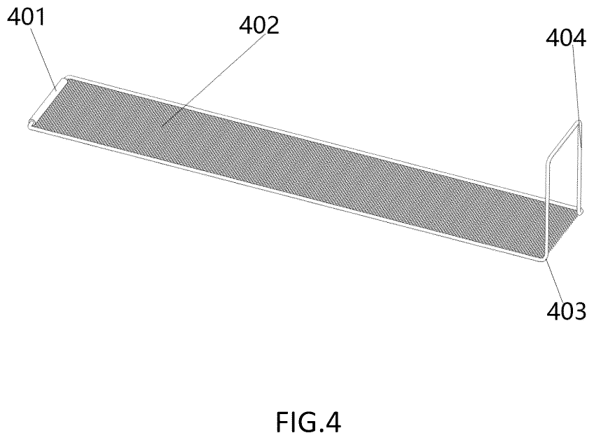

Referring to FIG. 4, the layer board 4 with the pivot 401 on the left end, the handle 404 on the right end, the handle 404, and the nylon mesh cloth 402, divided the left chamber into two layers, lifting the handle to open, pressing down the handle to lock;

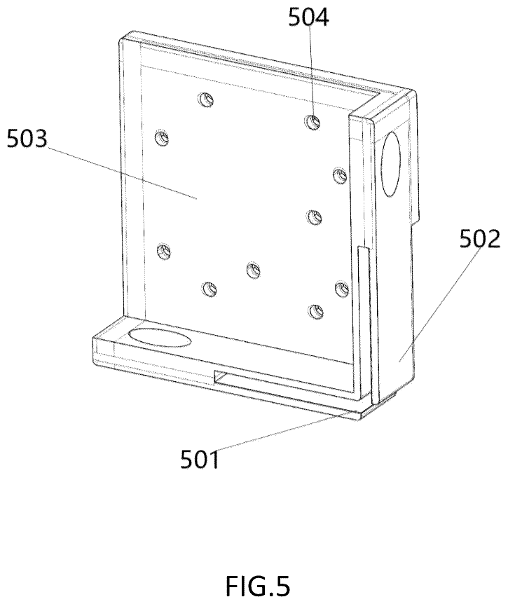

Referring to FIG. 5, the function expansion device 5, according to the embodiment, comprises two insert boards 501, 502, for connecting the main body's connection port 103, and function expansion device frame 503 which is used to install preset functional apparatus;

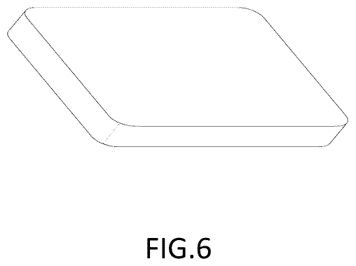

Referring to FIG. 6, padding piece 6 is used for filling the fillable space 203.

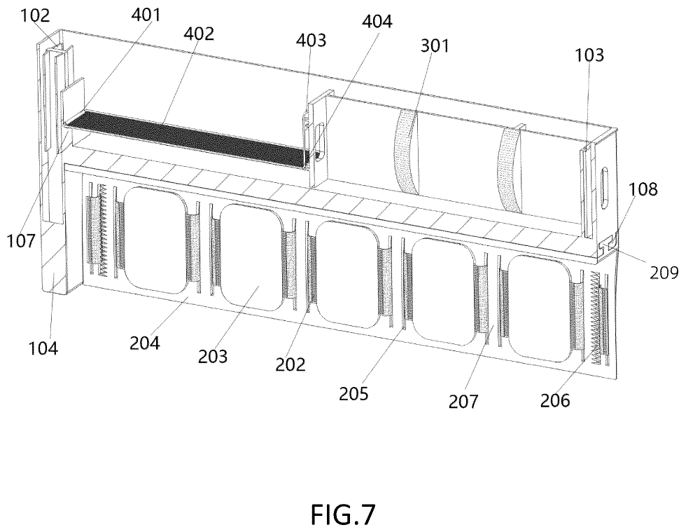

Referring to FIG. 7, the handle 404 presses against the grooves 304 of the partition baffle 3;

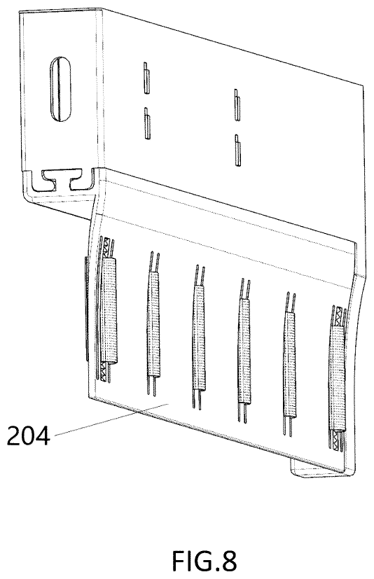

Referring to FIG. 8, reflecting the characteristics of single layer board 204, even in the case of narrow gap of car seat, the single layer board 204 thickness will be a thin board, thin enough to insert into the gap, demonstrating the universality;

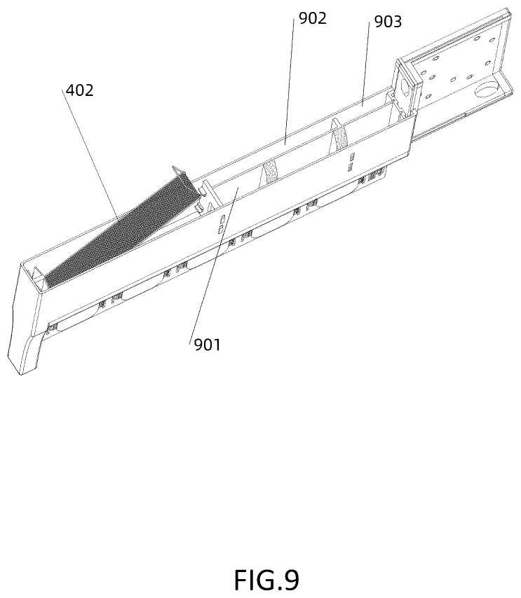

Referring to FIG. 9, indicating the characteristics of the classification storage of the present invention, the room 901 is for communication terminal, the room 902 is for diary or note paper, the room 903 is for cards;

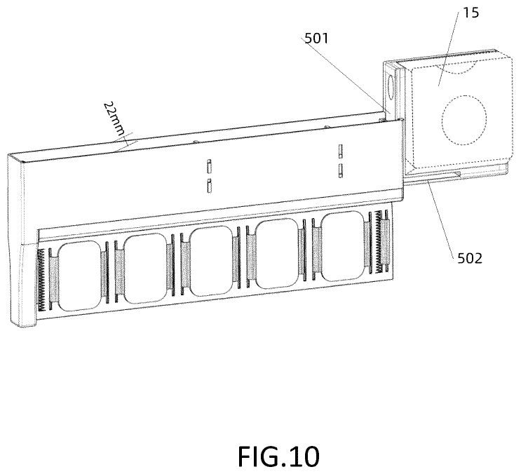

Referring to FIG. 10, this demonstrates the width of the present invention is narrow to be 22 mm, not occupy the seat space, folding state of foldable cup holder, the status for personnel in the right car seat.

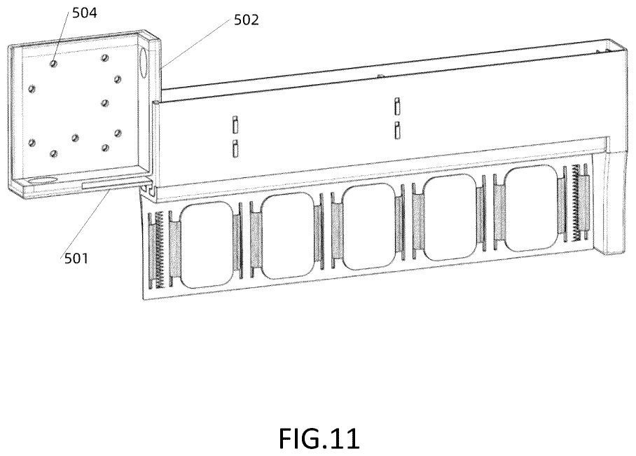

Referring to FIG. 11, showing the status for personnel in the left car seat;

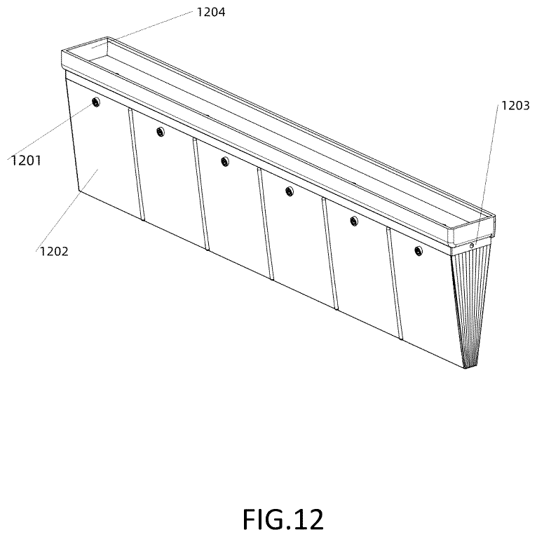

Referring to FIG. 12, showing an alternative solution, comprises the user adjustable gap filling device: airbag 1202, air valve 1201, inflation hole 1203, the docking device 1204.

### Description of A User Adjustable Gap Filling Device

### According to The Embodiment 1

Referring to FIG. 7, fourteen long strip holes 205 on the single layer board 204, is passed through by one entire elastic band 202 forming five flexible space 203, to the narrow seat gap, use less padding pieces to fill, to the wider seat gap, use more padding pieces to fill.

### Description of a User Adjustable Gap Filling Device

### According to The Embodiment 2

Referring the FIG. 12, an alternative solution, comprises the main body docking device1204 with an airbag, the airbag is set as six small airbags 1202 that can be individually inflated, sharing one inflation hole 1203, if the gap in a certain part of the car seat is the narrowest, it indicates that the required air intake is the smallest, when inflating, the six small airbags are inflated together, after injecting a certain amount of the air, the narrowest small airbag need to be closed by air valve 1201 at first, and the remaining five small airbags are continued to be inflated, then to close the airbags with the smallest required air intake among five, and the other four small airbags are continued to be inflated, the last one that is closed is at the widest gap of seat and requires the largest air intake, the required inflation tool is a regular basketball inflator.

### Description of The Sharp or Strip Shaped Items Organizing Device

### According to The Embodiment 1

Referring the FIG. 1, two pairs of clips made of elastic material, at different angle on the left side of main body 1, connect to the trapezoidal container 104 below, forming a long storage space that can hold pointed items, screwdrivers, pens.

### Description of The Tiny or Small Item Organizing Device

### According to The Embodiment 1

Referring the FIG. 7, FIG. 9, the layer board 4 installed on the shaft seat 107 of the main body 1, the handle 403 presses against the groove 304 of the partition baffle 3, forming a closed space to store small items, like earrings, necklaces, fishing hooks, the upper layer can store sun glasses.

### Description of The Functional Expansion Device

### According to The Embodiment 1

Referring the FIG. 10, FIG. 11, FIG. 5, the functional expansion device 5 mounted with a foldable cup holder 15, is connected the main body 1 by an insert board 501 to achieve functional expansion; to connect the main body 1 using another insert board 502 can change the functional expansion device' facing direction, catering to the different usage habits of left and right car seat occupants; the installation holes of the folding cup holder are pre-set and need to match the holes 504 of the functional expansion device 5, due to the use of a functional expansion device, the overall width of the present invention is about 22 millimeters, greatly saving seat space, other external function devices configuring to the main body are omitted in the embodiment.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the claims.

What is claimed is:

1. A universal use car seat gap filler or organizer, comprising:
A user adjustable gap filling device;
A sharp or strip shaped item organizing device;
A tiny or small item organizing device;
A functional expansion device.

2. A user adjustable gap filling device, as in claim 1, comprises a docking device for connecting the main body and an elastic band configured onto a single layer board, the elastic band is divided into plurality sections, forming plurality elastic spaces between the single-layer board, the filling material is a padding pieces.

3. The user adjustable gap filling device, as in claim 1, comprises a docking device for connecting the main body, and an airbag which is configured as plurality inflatable small airbags, and the filling material is the air, this is optional user adjustable gap filling devices solution.

4. The sharp or strip shaped items organizing device, as in claim 1, configured to right side of a main body, comprises different-angle clips made of elastic material, a trapezoidal container below, forming a room for storing sharp or strip shaped items.

5. The tiny or small item organizing device, as in claim 1, comprises a layer board, a pivot, and a handle, installing the pivot to a shaft seat of the main body, the layer board can be rotated up and down, the handle will press against the groove of a partition baffle while the layer board is placed horizontally, the chamber of the main body is divided into two layers, the lower layer is a relatively independent enclosed space for storing tiny and small items.

6. The functional expansion device, as in claim 1, configured onto the main body, comprising external device with more function, realizing more functions expansion.
